(19) United States
(12) Patent Application Publication
(10) Pub. No.: US 2015/0015481 A1
(43) Pub. Date: Jan. 15, 2015

(54) Gesture Recognition Systems

(71) Applicant: Bing Li, Bothell, WA (US)

(72) Inventor: Bing Li, Bothell, WA (US)

(21) Appl. No.: 14/331,174

(22) Filed: Jul. 14, 2014

Related U.S. Application Data
(60) Provisional application No. 61/845,887, filed on Jul. 12, 2013.

(51) Int. Cl. G06F 3/01

(52) U.S. Cl. CPC G06F 3/017
USPC 345/156

(57) ABSTRACT

A system including a first radiation source providing a first beam and a second radiation source providing a second beam, and a radiation sensor, wherein the first beam does not overlap the second beam. In some embodiments, the radiation comprises infrared radiation. A gesture recognition system including at least one infrared sensor, a first infrared light emitting diode (LED) providing a first far-field radiation beam that extends from the first infrared LED and defines a first central ray, a second infrared light emitting diode (LED) providing a second far-field radiation beam that extends from the second infrared LED and defines a second central ray, wherein the first central ray and the second central ray define a single intersection point and an angle of intersection.

### TECHNICAL FIELD

The present disclosure pertains to electronic devices having a proximity sensor. More particularly, the present disclosure pertains to gesture recognition devices and methods.

### BACKGROUND

Gesture recognition has been developed for use in, for example, gaming, virtual reality, high-end tablets and smart phones, etc. Advanced gesture recognition technology may use real-time video and very complex algorithms, but has been cost prohibitive. Lower cost gesture recognition has been based on a single proximity sensor, for example as discussed in US Patent Application Publication No. 2011/0310005, the entire disclosure of which is hereby incorporated herein by reference.

The accuracy and reliability of gesture recognition technology has depended on, for example, the distance and the moving range of the gesturing object (a user's palm, for instance) related to a proximity sensor. In some cases, multiple infrared light emitting diodes (LEDs) have been used to, for example, improve the complexity of the gestures that a system can recognize. However, the LEDs have been placed a substantial distance away from one another. In many cases, this substantial distance between LEDs has led to use of multiple holes opened on the front panel of a smart phone or tablet with an appropriate distance in between, which has been troublesome and/or unacceptable. Gesture recognition systems have also been limited in the ability to recognize gestures depending on the distance of a gesturing object from the system. For example, if a gesturing object is too close, the infrared beams might not be reflected back to the sensor. If the gesturing object is too far away, the infrared beams may get mixed (e.g., undesirably overlap) and render the system unreliable.

Therefore, there is a need for improved gesture recognition devices.

All patents, patent applications, and all other published documents mentioned anywhere in this application are incorporated herein by reference, each in its entirety.

Without limiting the scope of the invention a brief summary of some of the claimed embodiments is set forth below. Additional details of the summarized embodiments and/or additional embodiments of the present disclosure may be found in the Detailed Description below.

A brief abstract of the technical disclosure in the specification is provided as well only for the purposes of complying with 37 C.F.R. 1.72. The abstract is not intended to be used for interpreting the scope of the claims.

### SUMMARY

One aspect of the present disclosure is a gesture recognition system that includes a first radiation source providing a first beam that defines a first central ray (e.g., light ray, etc.), a second radiation source providing a second beam that defines a second central ray (e.g., light ray); and a radiation sensor. In one or more embodiments, the first central ray is oriented at a non-zero angle to the second central ray. In one or more embodiments, the first beam does not overlap the second beam.

Another aspect of the present disclosure is a system (e.g., a gesture recognition system, etc.) including at least one infrared proximity sensor and first and second infrared light emitting diodes (LEDs). The first infrared light emitting diode (LED) provides a first far-field radiation beam that extends from the first infrared LED and defines a first central light ray. The second infrared light emitting diode (LED) provides a second far-field radiation beam that extends from the second infrared LED and defines a second central light ray. In one or more embodiments, the first central light ray and the second central light ray define a single intersection point and an angle of intersection.

In some embodiments, a gesture recognition system comprises at least one radiation sensor, a first radiation source providing a first far-field radiation beam and a second radiation source providing a second far-field radiation beam. In some embodiments, the first far-field radiation beam does not overlap with the second far-field radiation beam. In some embodiments, at least one of the radiation sources comprises a light emitting diode (LED). In some embodiments, the first and/or second beam comprises infrared light. In some embodiments, at least one of the radiation sources comprises a laser.

In some embodiments, the gesture recognition system further comprises a cover, and at least one beam passes through the cover. In some embodiments, the first beam and the second beam each pass through the cover. In some embodiments, the cover also covers the radiation sensor, and reflections of the beams pass through the cover on the way to the radiation sensor. In some embodiments, the cover comprises a single, continuous piece of material.

In some embodiments, the first central ray and the second central ray are non-parallel. In some embodiments, the first central ray is oriented at a non-zero angle to the second central ray. In some embodiments, the non-zero angle is greater than a divergence angle of the first beam. In some embodiments, the non-zero angle is greater than a divergence angle of each of the first beam and the second beam.

In some embodiments, the first central ray and the second central ray are non-parallel after passing through the cover. In some embodiments, the first central ray and the second central ray are parallel prior to passing through the cover.

In some embodiments, the gesture recognition system comprises a radiation source driver circuit. In some embodiments, the driver circuit is synchronized with the radiation sensor, and configured to drive the radiation sources with a time-division multiplexing method. In some embodiments, an algorithm processor receives a signal from the radiation sensor and identifies a gesture.

In some embodiments, the gesture recognition system comprises a protruding substrate that comprises a first portion and a second portion oriented at an angle to the first portion, and at least one of the first and second portions has at least one of the first and second radiation sources disposed therein or thereon.

In some embodiments, the gesture recognition system comprises a module that comprises at least first and second compartments. In some embodiments, the first compartment comprises the radiation sources and the second compartment comprises the radiation sensor. In some embodiments, each compartment comprises its own cover. In some embodiments, the first compartment is optically separated from the second compartment.

In some embodiments, the gesture recognition system further comprises a third radiation source providing a third beam, the third beam not overlapping the first beam, the third beam not overlapping the second beam.

In some embodiments, the gesture recognition system further comprises a fourth radiation source providing a fourth beam, the fourth beam not overlapping any of the other beams.

### BRIEF DESCRIPTION OF THE DRAWINGS

A detailed description is hereafter provided with specific reference being made to the drawings.

FIG. 1 shows a 2-LED gesture recognition system according to one or more embodiments of the present disclosure.

FIG. 2 shows a spherical distribution of a radiation beam of an infrared LED of a gesture recognition system according to one or more embodiments of the present disclosure.

FIG. 3 shows a gesture recognition system including four radiation sources according to one or more embodiments of the present disclosure.

FIG. 4 shows a gesture recognition system including three radiation sources according to one or more embodiments of the present disclosure.

FIGS. 5 and 6 show examples of spherical distribution of radiation beams along the polar angle.

FIG. 7 shows a radiation source configuration in a gesture recognition system according to one or more embodiments of the present disclosure.

FIG. 8 shows another radiation source configuration in a gesture recognition system according to one or more embodiments of the present disclosure.

FIG. 9 shows an example of distribution of radiation beams on a spherical surface as translated to a two-dimensional coordinate system.

FIG. 10 shows another a gesture recognition system according to one or more embodiments of the present disclosure.

While the disclosure is amenable to various modifications and alternative forms, specifics thereof are shown by way of example in the drawings and are described in detail. It should be understood, however, that the intention is not to limit the present disclosure to the particular embodiments described. On the contrary, the intention is to cover all modifications, equivalents, and alternatives falling within the scope of the present disclosure.

### DETAILED DESCRIPTION

The subject matter of the present disclosure may alleviate or eliminate one or more of the problems mentioned above. The following description should be read with reference to the drawings, which are not necessarily to scale, wherein like reference numerals indicate like elements throughout the several views. The detailed description and drawings are intended to illustrate but not limit the present disclosure. Those skilled in the art will recognize that the various elements described and/or shown may be arranged in various combinations and configurations without departing from the scope of the disclosure. The detailed description and drawings illustrate example embodiments of the present disclosure.

For the purposes of this disclosure, like reference numerals in the figures shall refer to like features unless otherwise indicated.

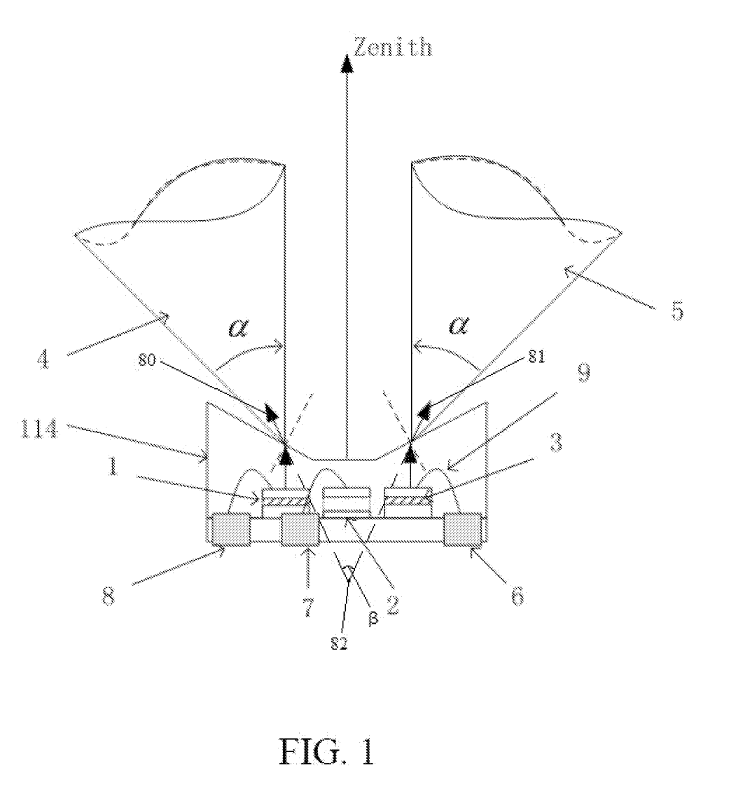

In at least one aspect of the present disclosure, a system (e.g., a gesture recognition system) is shown in FIG. 1. The device includes a first radiation source 1 (e.g., an LED), a second radiation source 3 (e.g., an LED), and a radiation sensor 2 (e.g., an LED). First radiation source 1 provides a first beam of radiation (e.g., light, infrared light, etc.) that defines a first central light ray 80 and a first divergence angle α. Similarly, second radiation source 3 provides a second beam of radiation (e.g., light, infrared light, etc.) that defines a second central light ray 81 and a second divergence angle α. In at least some embodiments of the present disclosure, the first central light ray 80 is oriented at a non-zero angle relative to the second central light ray.

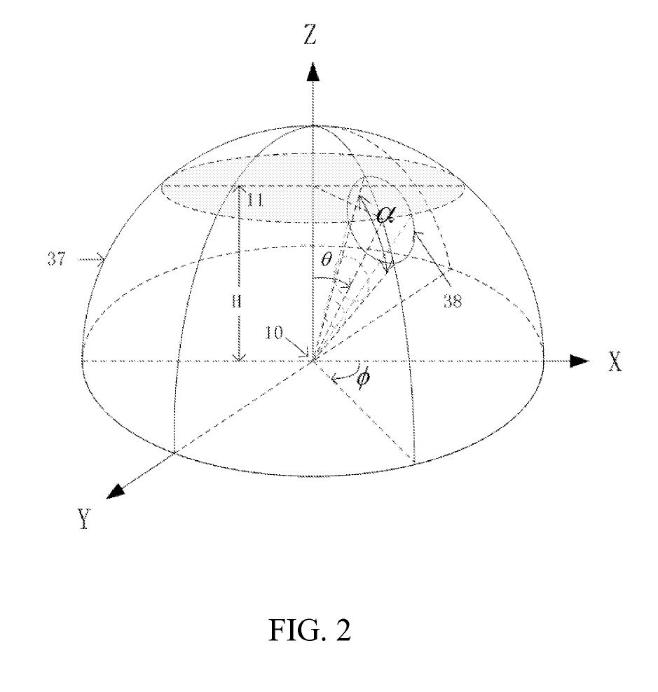

In one or more embodiments, a gesture recognition system may include a cover, structured and arranged to allow transmission of at least a first radiation beam through the cover. In FIG. 1, the first central light ray 80 is shown as an arrow that represents a central axis along which the radiation beam extends after the radiation beams leaves cover 114. Also, divergence angle α is shown in FIG. 1 for first radiation beam and second radiation beam. Herein, a divergence angle is a measure of the angle across a generally conical radiation beam (i.e., increasing beam diameter with increasing distance from the beam source). A central light ray may be defined in, for example, a spherical coordinate system, as shown in FIG. 2. Divergence angle α is also shown in FIG. 2 with reference to a spherical coordinate system. As used herein, unless otherwise specified, the divergence angle is measured with reference to the portion of a beam of radiation that is emitted from the system (e.g., spaced apart from the radiation sources and located in the area where gestures are made; the far-field beams, etc.).

In the embodiments of the present disclosure, any of a wide range of radiation sources may be utilized, including, but not limited to an LED, a laser, a vertical cavity surface emitting laser, etc. In the present disclosure, while reference is made to “LED,” “infrared LED,” and “LED chip,” it should be understood that embodiments including an LED source of radiation are exemplary of radiation sources and are not limiting. In the present disclosure, one or more of the radiation sources may include an infrared LED. In one or more embodiments, at least one radiation source includes a source of infrared radiation (e.g., an infrared LED) and at least one other radiation source includes a source of radiation that is not infrared (e.g., UV, visible, x-ray, etc.). In one or more embodiments, at least one radiation source includes a source of radiation having a first wavelength and at least one other radiation source includes a source of radiation having a second wavelength wherein the first and second wavelengths may be the same or different (e.g., different infrared wavelengths, different x-ray wavelengths, an infrared wavelength and a visible light wavelength, etc.). In some embodiments, a gesture recognition system may include at least one source of radiation that includes an LED that is a source of infrared (or other radiation) and/or includes at least one other source of radiation that is not an LED (e.g., a laser), but provides infrared (or other radiation). In some embodiments, at least one (e.g., all) of the radiation sources provides a radiation beam that defines a fixed central ray direction.

In the embodiments of the present disclosure, any of a wide range of radiation sensors may be utilized, including, but not limited to infrared sensors. In the present disclosure, while reference is made to “infrared sensor” and “sensor chip,” it should be understood that embodiments including an infrared radiation sensor are exemplary of radiation sensors suitable for detecting radiation emitted by radiation sources and are not limiting.

Although the system depicted in FIG. 1 includes two radiation sources (e.g., LEDs), some embodiments may include additional radiation sources.

As shown in FIG. 1, a first infrared LED 1, an infrared proximity sensor 2, and a second infrared LED 3 are mounted on a substrate and are placed (e.g., located, disposed, etc.) very close to each other in, for example, a module. As a result of this close proximity of the first and second radiation sources and the proximity sensor, some embodiments may include a single hole (e.g., aperture) on a panel of an apparatus that the module will be applied to.

In FIG. 1, the first and second LED chips, 1 and 3, and the proximity sensor chip 2 are attached to (e.g., packed on) the same substrate and, more generally, the same sealed module. A frame (e.g., lead frame, etc.), including an electronic (e.g., metal, etc.) connection between all the chips and the lead going to the outside the package (e.g., lead 8 for LED chip 1, lead 7 for sensor chip 2, and lead 6 for LED chip 3), is part of the substrate on which the chips may be mounted. In FIG. 1, examples of bonding wires 9 are shown for each of the first and second radiation sources, 1 and 3, and the radiation sensor 2.

In one or more embodiments, a radiation sensor may be located between two or more radiation sources, as shown in FIG. 1. In one or more embodiments, three or more radiation sources may be arranged on a substrate, the radiation sources defining an outer perimeter, wherein at least one radiation sensor is disposed within the outer perimeter. In some embodiments, a radiation sensor is not located between two or more radiation sources (e.g., the first and second radiation sources).

In one or more embodiments, a gesture recognition system may include a third radiation source (e.g., third infrared LED) that provides a third beam (e.g., a third far-field radiation beam) defining a third central light ray and a divergence angle. In some embodiments, the third central light ray may be oriented in a direction that is different from the first central light ray direction and different from the second central light ray direction. In some embodiments, the third central light ray may extend through an intersection of the first and second central light rays. The intersection point 82 may provide a point of reference for an original point of a spherical coordinate system. It may be useful to locate one or more radiation sources and sensor(s) near that intersection point 82 (or as near as is practical). In or more embodiments, the third beam does not overlap with the first beam or the second beam. In some embodiments, the overlapping of beams is insignificant or negligible. In one or more embodiments, an infrared sensor (e.g., infrared proximity sensor) may be disposed not greater than two (e.g., not greater than 1.75, not greater than 1.5, not greater than 1.25, not greater than 1.0, etc.) times the distance from the first infrared LED to the intersection point 82. In some embodiments, an infrared sensor may be disposed greater than two times the distance from the first infrared LED to the intersection point 82.

With reference to the cover (e.g., of FIG. 1), cover 114 (e.g., a transparent cover) may be attached to (e.g., connected to, molded to, bonded to, etc.) the substrate or other portion of a module and may cover and/or seal one or more LEDs and one or more radiation sensors (e.g., sensor chips) while allowing the first beam to pass through the cover. In one or more embodiments, as shown in FIG. 1, cover 114 may include a single solid piece attaching (e.g., gluing) with the LEDs and sensor chip.

In one or more embodiments, the cover includes a first portion and a second portion, wherein, for example, the first beam may pass through the first portion of the cover and the second beam may pass through the second portion of the cover. In some embodiments, the cover includes a third portion, and a reflection of at least one of the first beam and the second beam passes through the third portion (e.g., toward a radiation sensor). In some embodiments, the first beam and the second beam may pass through the cover, wherein the first central light ray 80 and the second central light ray 81 are parallel prior to passing through the cover. In some embodiments, the first central light ray 80 within the cover (e.g., prior to leaving the cover, etc.) is directed 10 degrees or less (e.g., 5 degrees or less, 1 degree or less, etc.) from parallel with the second central light ray 81 within the cover (e.g., prior to leaving the cover).

In some embodiments, cover 114 has a concave shape on the top (e.g., on a surface facing away from at least one radiation source). In one or more embodiments, the concavity may diffract one or more of the radiation beams from the LEDs to a direction that is away from the zenith axis. The cover can be made from any of a wide variety of suitable materials including, but not limited to, polymers. In some embodiments, a cover may take the form of a single, integral (e.g., continuous) piece of material. In some embodiments, a plurality of covers may be used, each of which may cover one or more radiation sources and/or one or more radiation sensors.

With reference to FIG. 2, in some embodiments, a radiation beam from a radiation source may be arranged or described according to spherical coordinates. A gesture recognition system may arrange a plurality of radiation beams such that the central light ray of each radiation beam is located at a different polar angle (θ) and/or azimuth angle (φ) relative to the central light ray of one or more (e.g., all) of the other radiation beams. In one or more embodiments, the (θ,φ) coordinates will be sufficiently different such that the corresponding radiation beams will not overlap to each other no matter from how far away the LED sources are inspected. In one or more embodiments, the (θ,φ) coordinates will be sufficiently different such that the corresponding radiation beams will theoretically overlap, but will theoretically do so at a distance from the original point of the spherical coordinate system that is greater than (e.g., at least 10% greater than, at least 50% greater than, at least 100% greater than, at least 1,000% greater than, etc.) a useful distance for gesture recognition. In one or more embodiments, a useful range for recognizing gestures may include any suitable distance depending on the application of the gesture recognition system. For example, for hand-held devices (e.g., smart phone, etc.), the range of recognizing gestures may include distances that are very close to the hand-held device (e.g., at least 0.1 millimeters). In another application such as gaming and/or virtual reality, the range may include distances of at least 2 centimeters to 3 meters, 5 meters, 10 meters, or even longer. In one or more embodiments, a useful range for recognizing gestures may be outside of these ranges, either closer or farther away.

In FIG. 2, the divergence angle of the first and second far field radiation beams, four and 5, from the LEDs is α. As long as the angle between the central light rays of the beams is larger than α, the two beams 4 and 5 will not overlap, no matter where the radiation beams are evaluated (e.g., no matter how far from the radiation source the beams are inspected).

In one or more embodiments, avoiding overlap of at least two radiation beams may increase the volume of locations where gestures may be reliably recognized, relative to known gesture recognition systems (that use a proximity sensor) wherein some gestures are between or outside of the first and second radiation beams or in a significantly overlapping portion of first and second radiation beams.

In the present disclosure, the infrared LEDs and the proximity sensor can be placed (e.g., disposed) very close to each other. In one or more embodiments, the near-field radiation from the LEDs to the sensor can be blocked by appropriately arranging the packaging. In one or more embodiments, the far-field radiation beams from two or more (e.g., all) of the infrared LEDs are each arranged along different polar and/or azimuth angles in a common spherical coordinate system. In one or more embodiments, first and second radiation beams do not overlap and do not converge at a common point (e.g., an original point of a spherical coordinate system) and/or the central rays of the first and second radiation beams do not intersect (e.g., skew, etc.).

In the present disclosure, if two central rays (e.g., a first central ray and a second central ray) are skew (i.e., representing non-parallel lines that do not intersect), then the angle of intersection β between such central rays will be defined by the angle between (a) the first central ray and (b) a line that is parallel to the second central ray and that intersects both (i) the first central ray and (ii) a line segment connecting the first and second central rays and representing the shortest distance between the two lines.

To further describe the spherical distribution of the radiation beams from the one or more radiation sources (e.g., infrared LEDs), FIG. 2 shows an illustration of a spherical coordinate system 37 and how a radiation beam may be positioned in some embodiments. The gesture recognition module, including the sensors and LEDs, may be located at the original point 10 (e.g., the center) of the spherical coordinate system. When considering the far-field radiation beam, it should be understood that one or more radiation sources (e.g., LED chips) and one or more sensors are placed sufficiently close to each other so that at least two or more (e.g., all) of the far-field radiation beams from different LEDs may be considered to be extending from a common point, the original point 10. In a far-field beam, the nearfield pattern of the beams may be ignored. In one or more embodiments, when the distances for recognizing gestures is far enough, the radiation sources and radiation sensor(s) may be considered as located at a single point.

In one or more embodiments, the first radiation source (e.g., infrared LED source) may be placed in physical contact with the second radiation source, as long as both radiation sources remain operable (e.g., do not malfunction due to an electrical short, etc.). In one some embodiments, the first radiation source may be placed any distance from the second radiation source, so long as the radiation sensor may detect light from both of the first and second radiation sources as reflected by an object gesture. In many practical applications, the first and second radiation sources may be in very close proximity to allow the optical window through which the beams pass to remain relatively small.

Only one radiation beam 38 is shown in FIG. 2. Radiation beam 38 defines a polar angle θ, an azimuth angle φ, and a divergence angle α. In FIG. 2, the spherical coordinate system 37 has a cross-section 11 that is parallel to the XY plane and happens to include the center point of the radiation beam 38 (e.g., the central light ray of radiation beam 38 extends through the intersection of cross-section 11 and a reference sphere having a particular radius. The radiation beam 38 will have an elliptic shape of projection on cross-section plane 11. In one or more embodiments having at least two LEDs present in a gesture recognition system, the far-field radiation beams of the at least two LEDs may have a divergence angle α and may be distributed so that the associated central light rays extend from the original point 10 of the same spherical coordinate system 37 and define different polar angle and/or azimuth angles so that the beams will not overlap.

In FIG. 1, the angle between the first and second central light rays extending from the cover 114 is non-zero. In one or more embodiments, the non-zero angle between the first and second central light rays is greater than the divergence angle α of the first radiation beam. For example, as shown in FIG. 1, the angle between the central light rays of radiation beams 4 and 5 is greater than the divergence angle α of the first beam and is greater than the divergence angle α of the second beam. It should be recognized that, in some embodiments, the divergence angle α of the second beam is equal to or less than the divergence angle α of the first beam. In some embodiments, the divergence angle α of the second beam is greater than the divergence angle α of the first beam. In practical application, it may be noted that increasing the angle between the first and second central rays may affect the performance of the gesture recognition system at long distances from the radiation sensor.

In some embodiments, wherein a zenith axis is defined to be normal to the radiation sensor, an angle between the zenith axis and the first central light ray 80 may be approximately half of the non-zero angle between the first and second central light rays. In some embodiments, an angle between the zenith axis and the second central light ray 81 may be approximately half of the non-zero angle between the first and second central light rays.

With further reference to FIG. 1, in another aspect of the present disclosure, a gesture recognition system may include at least one infrared sensor 2, a first infrared light emitting diode (LED) 1, and a second infrared light emitting diode (LED) 3. The first infrared LED 12 may provide a first far-field radiation beam 16 that extends from the first infrared LED 12 and defines a first central light ray. The second infrared LED 15 may provide a second far-field radiation beam that extends from the second infrared LED 15 and defines a second central light ray. In one or more embodiments, the first central light ray 80 and the second central light ray 81 define an intersection point 82 and an angle of intersection β, the angle of intersection β being large enough to avoid an overlap between the first and second far-field radiation beams. In one or more embodiments, the distance between the first and second infrared LEDs is shorter than 1 centimeter (e.g., shorter than 0.1 cm, shorter than 10 micrometers, etc.).

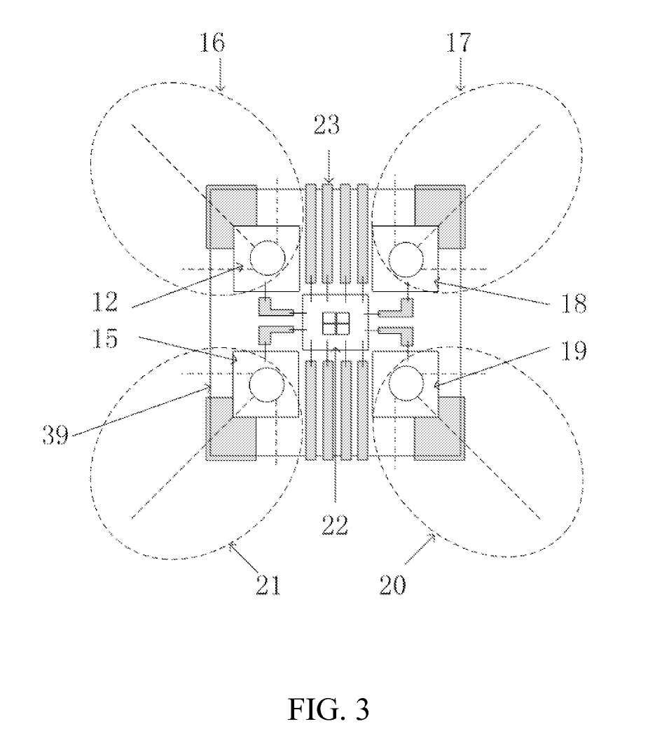

In the present disclosure, a gesture recognition system may include more than two radiation sources (e.g., four or more, five or more, six or more, 10 or more, 20 or more, 100 or more, etc.). FIG. 3 depicts a top view of one or more embodiments of a gesture recognition system according to the present disclosure. The gesture recognition system includes at least one infrared radiation sensor 22 (e.g., an infrared proximity sensor) and four radiation sources 12, 15, 18, 19 (e.g., infrared LEDs). All the chips (sensor and LEDs) are shown mounted on a substrate 39 having a lead frame. In one or more embodiments, a quad-flat no-leads (QFN) package may be used, leads may be bent, and a soldering pad may be located underneath substrate 39. One of the examples of a lead is shown in FIG. 3 as lead 23 associated with (e.g., electronically engaged with) the sensor chip.

Each of the far-field radiation beams from the LEDs 12, 15, 18, 19 is illustrated by a representative projection spot on a cross-section plane (similar to cross-section plane 11 in FIG. 2). Each projection spot 16, 21, 17, and 20 takes an elliptical shape, as disclosed above. Other shapes of projection spots are possible and depend on the shape of the radiation beam (e.g., circular shown in FIG. 3) and the surface on which the beams are projected (planar surface normal to the zenith axis). Projection spots 16, 21, 17, and 20 correspond with LEDs 12, 15, 18, and 19, respectively. The center circle of each LED 12, 15, 18, and 19 is the active area from which the light will emit. In FIG. 3, because an edge of the projection spot is very close to an edge of the circular active area of each LED, it can be envisioned that the inner boundary of each far-field radiation beam (i.e., the edge of the beam closest to the zenith axis) is vertical (e.g. parallel to the zenith axis of the spherical coordinate system) or substantially vertical (e.g., deviating only slightly from parallel to the zenith axis of the spherical coordinate system).

As shown in FIG. 3, the four LED beams (represented by projection spots 16, 21, 17, and 20), are distributed in four different quadrature from the top view. In the spherical coordinate system, the polar angle and the azimuth angle of the four beams may be expressed as (α/2, 3π/4) for 16, (α/2, 5π/4) for 21, (α/2, 7π/4) for 20, and (α/2, π/4) for 17.

In one or more embodiments, the gesture recognition system with all the chips may be located approximately at the original point 10 of a spherical coordinate system.

With reference to FIG. 3, an algorithm processor of a gesture recognition system of the present disclosure may be described. When an object (e.g., a gesturing object such as a hand, finger, etc.) moves above the device (e.g., through one or more of the radiation beams), its moving trace and direction will determine which beam it will cover and in what sequence. If the object moves along a circle that intersects with (e.g., passes at least partially through) the four beams of FIG. 3, for instance, the four beams will get partially or completely covered alternatively and provides the scattering (e.g., reflected) light in a return direction toward the proximity sensor (among other directions) in that particular sequence as well. In one or more embodiments that include four beams, clockwise and counter-clockwise gestures may be recognized. A three-dimensional (3D) gesture may be recognized even when the object is not directly on top of a gesture recognition system (in the general direction of the zenith axis), since a plurality of beams may cover a wide spherical angle range that may or may not depend on the distance from the device.

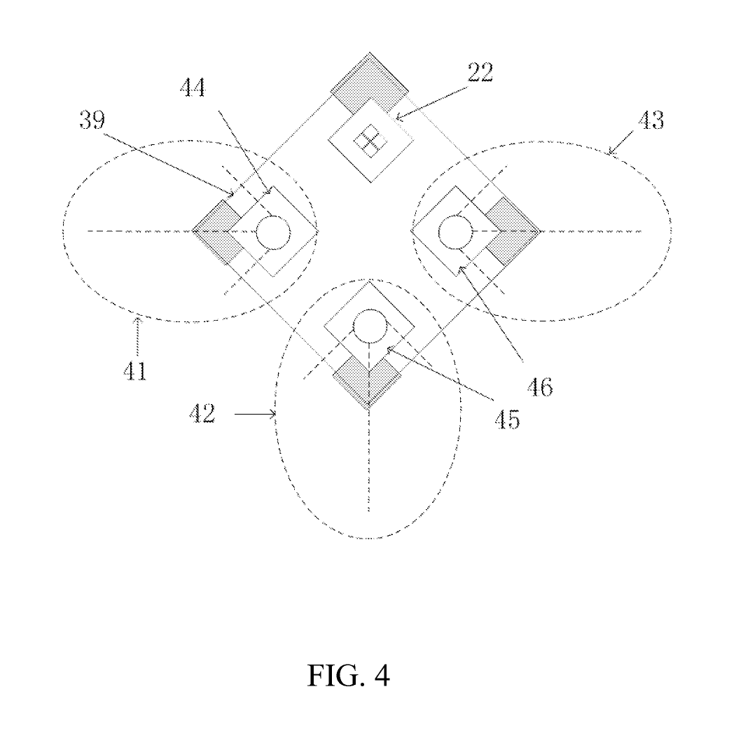

One or more embodiments of the system according to FIG. 4 include three LEDs, 44, 45, and 46. The far-field radiation beams from those LEDs are 41, 42, and 43 respectively. The system may also include a proximity sensor 22. All four chips shown to be are mounted on the substrate 39 in a square layout. A wide variety of layouts may be utilized in the present disclosure. In FIG. 4, the polar and azimuth angles of the radiation beams in the spherical coordinate system are (α/2,π) for 41, (α/2,3π/2) for 42, and (α/2,0) for 43. The tri-LED system of FIG. 4 is a different (e.g., simplified) version of the system in FIG. 3. In one or more embodiments, the systems of FIGS. 3 and 4 may be included in a panel of a smart phone or tablet computing device and may be user-friendly in these and a wide variety of other applications.

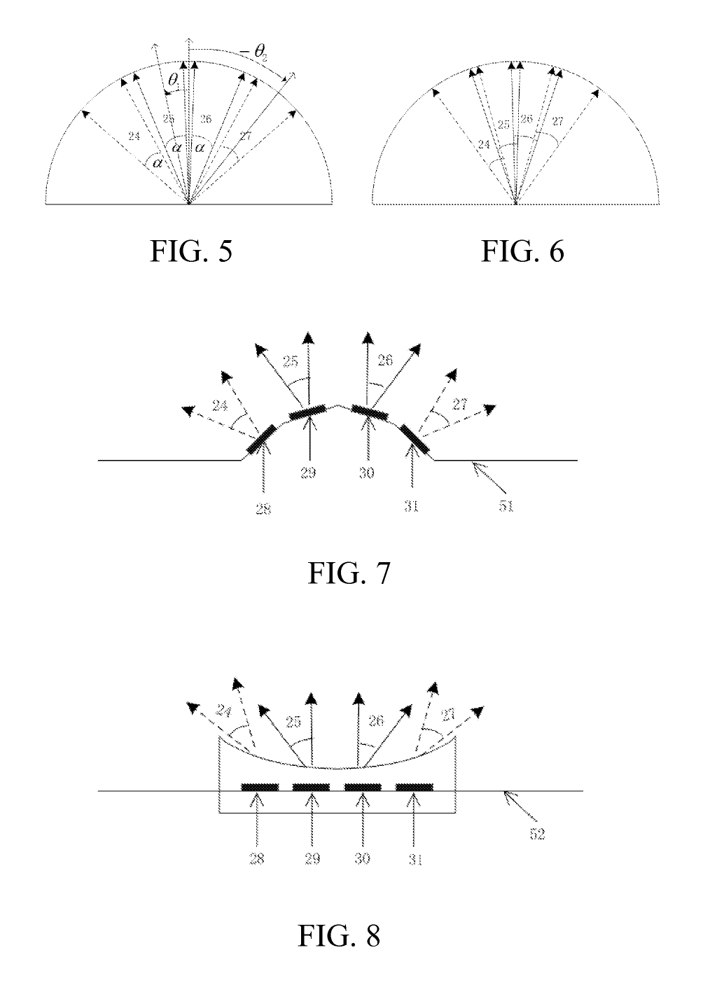

FIGS. 5 and 6 show examples of a cross-section plane of a constant azimuth angle for the spherical coordinate system 37 (see FIG. 2). Shown in each of FIGS. 5 and 6 are are four radiation beams 24, 25, 26, and 27 distributed along the polar angle. In FIG. 5, none of the four beams overlaps another beam, which means that the polar angle difference θ2−θ1 is more than the divergence angle of the beam (or more than the sum of half of the divergence angles of the two beams). In FIG. 6, the polar angle difference θ2−θ1 is slightly less than the divergence angle of the beam (or less than the sum of half of the divergence angles of the two beams). As a result, the beams 24, 25, 26, and 27 are slightly overlapping. In some embodiments, the angle of intersection β between the first and second central light rays of the first and second beams is larger than the divergence angle of at least one of the first and second far-field radiation beams.

One or more embodiments of the present disclosure may include one or both of the radiation source configurations of FIGS. 7 and 8.

To generate the far-field radiation beams as coming from a common original point (approximately) and distributed along the polar and azimuth angle in a spherical coordinate system, there are many ways of mounting and packaging radiation sources. In one or more embodiments, a gesture recognition system may include a protruding substrate that comprises a first portion and a second portion, wherein at least one of the first and second portions has at least one of the first and second infrared LEDs disposed therein or thereon. One or more of the portions of the protrusion may be side-facing or partially side-facing. In some embodiments, the protruding substrate may have a dome (e.g., geodesic dome shape) having a plurality of surfaces, one or more of which may have a radiation source mounted thereon. In one example, FIG. 7 depicts four LED chips mounted on four portions of a protruding substrate 51, which has a shape of polygon. In FIG. 7, on each portion (e.g., side) of the polygon there is one LED chip, which provides a radiation beam with a certain polar angle, azimuth angle, and divergence angle. Thus, in some embodiments, a plurality of radiation sources may be physically oriented (e.g., directed) at non-zero angles to one another and may contribute to providing the far-field radiation beams with either different polar or different azimuth angles, or both, in a common spherical coordinate system, which may avoid overlapping the beams, irrespective of the distance from the radiation source.

In FIG. 8, a slab substrate 52 is shown covering the LED chips with a lens (e.g., lens having a concave portion). It may be noted that the beam distributions shown in FIG. 5 or 6 may be generated the structures shown in FIG. 7 or 8.

In some embodiments, a gesture recognition system may include an LED driver circuit. In some embodiments, the LED driver circuit may be integrated into the system. In some embodiments, the LED driver circuit may be synchronized with an infrared sensor (e.g., a proximity sensor). In some embodiments, the LED driver circuit may be structured and arranged to drive the LEDs with a time-division multiplexing method. A gesture recognition system may also include an algorithm processor that may be coupled with the infrared sensor to receive a signal from the infrared sensor. In one or more embodiments, the signal may represent, for example, an intensity of a return light that is scattered by an object (e.g., a gesture object) from at least one of the first and second far-field radiation beams emitted from the LEDs in a time-division multiplexing manner. In one or more embodiments, the algorithm process is structured and arranged to identify a gesture. Identifying a gesture may include performing an analysis according to the signal received to determine a nature of the gesture. In one or more embodiments, a pattern of signals may be associated with a pattern of signals that is characteristic of a particular gesture. Associating the pattern of signals may include comparing the pattern to or contrasting the pattern with a plurality of patterns in a library of known gesture-pattern associations.

In one or more embodiments, the time-division multiplexing method may include, for example, assigning each LED with a time slot in a sequence, coupling a driving current to the LED within the time slot, wherein the radiation sensor (e.g., proximity sensor) regards the received light signal within the said time slot as the light signal from the LED assigned to the time slot. In the present disclosure, an algorithm processor may be either programmable or not programmable.

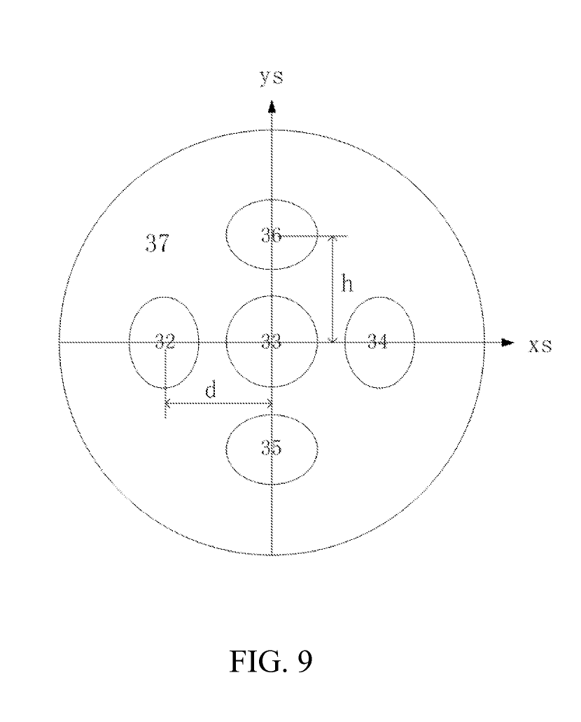

Another aspect of the present disclosure is using any of the gesture recognition systems of the present disclosure to recognize a gesture. A process of using the gesture recognition system can be explained with reference to FIG. 9. FIG. 9 shows a distribution of the facula (e.g., bright spots, illuminated spots, etc.) of the radiation beams from the respective LEDs on a sphere surface 37. There are five beam images (speckles) 32, 33, 34, 35, and 36 illustrated on the spherical surface 37. The (xs, ys) coordinate system is the 2-D Cartesian coordinate system on the spherical surface, and d and h is the spherical distance of the speckles from the center. In an algorithm of gesture recognition, the d and h may be measured by one or more angles, instead of linear distance. In such way, a calculation may stay true for any spherical surface where the gesture occurs.

It may be noted that in FIG. 9, the return light scattered by an object (e.g., gesture object) from center speckle 33 can be an indicator of the distance of the object vertically from the device, since the speckle 33 has the coordinates of (0,0) in the (xs,ys) system.

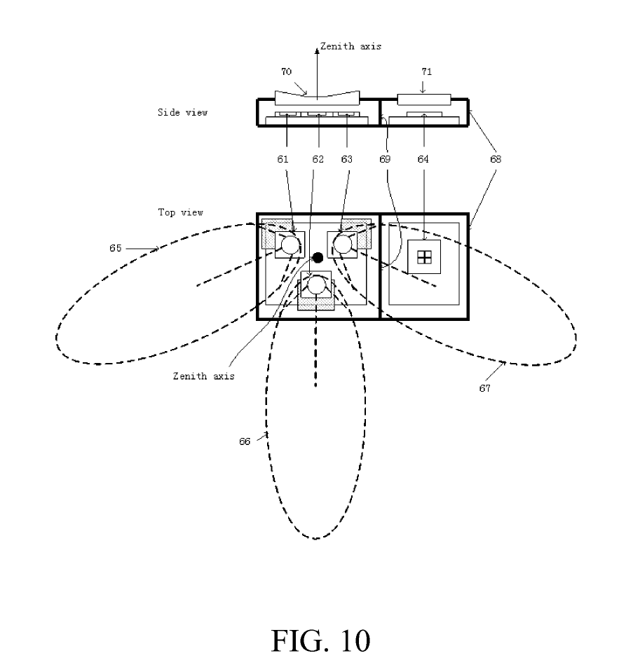

The embodiments described herein may have all of the LED chips and sensor chip(s) mounted together in one package (e.g., transparent package, partially transparent package, translucent package, partially translucent package, etc.). However, the isolation between LED chips and the sensor in the near-field may be useful. In some embodiments, an isolation barrier is designed into the package. One or more embodiments may include a module that includes at least first and second compartments, a first package including a first cover disposed in the first compartment, the first cover covering the first and second infrared LEDs, the first package disposed in the first compartment, a second package including a second cover covering the at least one infrared sensor (e.g., a proximity sensor), the second package disposed within the second compartment that is separated from the first compartment by an isolation barrier to prevent the near-field light couple from the first and second infrared LEDs to the sensor. In some embodiments, one or more of the first and second covers is transparent. For example, FIG. 10 depicts one or more embodiments of a gesture recognition system that includes an isolation barrier 69 located between two compartments of the module 68.

In one or more embodiments, any of a wide variety of infrared sensors may be utilized in the present disclosure. Some infrared sensors are commercially available, such as model Si1143 (Silicon Laboratories Inc., Austin, Tex.) which may drive, for example, 3 LED chips of a gesture recognition system.

Shown in the gesture recognition system of FIG. 10 are three LED chips 61, 62, and 63 mounted in a common package (e.g., transparent package). The package of all three LEDs is shown mounted in one of two compartments of a module 68, while another compartment contains a separate packaged infrared sensor (proximity sensor 64). Isolation barrier 69 may be disposed between two compartments of the module 68 in order to reduce or avoid near field light couple from all LEDs (61, 62, and 63) to the proximity sensor 64. Each compartment includes an opening (e.g., a transparent opening). For example, the compartment that holds the three LEDs includes opening 71 and the compartment that holds the proximity sensor 64 includes opening 72.

In one or more embodiments, an opening may include a hole, a window, a lens, etc. In some embodiments, the opening 71 may include a lens having a concave portion, a convex portion, or both. In FIG. 10, the lens shape may diverge the light beams from the LEDs. With the influence of the opening 71, the far-field radiation beams from all three LEDs are shown in FIG. 10 (top view). The polar angle and azimuth angle of the three beams are (α/2+b, −5π/6) for the beam 65 (far-field radiation beam of the LED 61), (α/2+b, −π/2) for the beam 66 (far-field radiation beam of the LED 62), and (α/2+b,−π/6) for the beam 67 (far-field radiation beam of the LED 63). Here, b is the bias angle and α is the divergence angle of the beam.

A non-zero bias angle may be useful to facilitate the user experience. For example, in one or more embodiments in which the gesture recognition system of the present disclosure is mounted to or on a tablet device or smart phone device, a user may face the top front part the sphere 37 (see FIG. 2). When adding a non-zero bias angle b, the radiation beams may illuminate a particular portion of the sphere where it is expected that gestures will be made most frequently (e.g., a central part of a top-front part of the sphere).

The ellipses shown in the top view in FIG. 10 are representative of the infrared beams passing through a cross section plane, such as the cross-section plane 11 of FIG. 2. The elliptic shape is the spot that the beam projects on the plane 11. When a bias angle b equals zero, the spots will distribute as shown in FIG. 10 (wherein an ellipse and an edge of the light source intersect at a tangent); and if a bias angle b is larger than zero, the spots will be further away from the location of the zenith axis (e.g., the portion of the beam that is closest to the zenith axis diverges from the zenith axis as the distance from the radiation source increases.

Note that the polar angle, azimuth angle, and divergence angle of each beam in FIG. 10 is just one example out of a wide variety of suitable polar angles, azimuth angles, and divergence angles. For example, in one or more embodiments, the divergence angle of the beam may be less than π/3 (1.47 radians), which may avoid overlap between two of the beams. In some embodiments, the divergence angle may be less than 1.0 radian, less than 0.80 radian, less than 0.60 radian, or less than 0.30. In some embodiments, the divergence angle may be greater than or equal to 0.6 milliradian, greater than or equal to 0.10 radian, greater than or equal to 0.50 radian, or greater than or equal to 1.0 radian. When the divergence angle of the beam increases, the difference of the azimuth angle between the beams might need to be adjusted (e.g., increased) in order to avoid overlap. If divergence angles are too large, system sensitivity at an increased distance from the sensor may be affected (e.g., negatively affected). However, if divergence angles are too low, then recognition of gestures close to the device may be more difficult to interpret. In one or more embodiments, it may be useful to increase polar angle of the beam 66 to larger than α/2+b, for a given α and b, in order to, for example, improve the performance of the system in certain mounting layouts.

In the one or more embodiments of FIG. 10, sensor 64 is in a package that is separate from the infrared sources, even though it is disposed close to the LEDs. As an alternative, the sensor may be disposed at a location that is not as close to the LEDs, especially in embodiments in which a gesturing object causes diffuse reflection (present in some gesture recognition applications) of the radiation from the LEDs.

In one or more embodiments, a sensor's location may be selected (e.g., the system may be designed) to facilitate recognizing a particular type of gesturing object. Herein, an “object” is an object that is moving to create a gesture. In one or more embodiments, the object includes, but is not limited to, one or more hands, fingers, arms, legs, a head, etc.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the present disclosure such that the present disclosure should be recognized as also specifically directed to other embodiments having any other possible combination of the features of the dependent claims. For instance, for purposes of claim publication, any dependent claim which follows should be taken as alternatively written in a multiple dependent form from all prior claims that possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the term “about” may include numbers that are rounded to the nearest significant figure.

The recitation or disclosure of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include plural references unless the context clearly dictates otherwise. As used in this specification and the appended claims, the term “or” is generally employed in its sense including “and/or” unless the context clearly dictates otherwise.

References in the specification to “an embodiment,” “some embodiments,” “one or more embodiments,” “other embodiments,” etc., indicate that the embodiment described may include a particular feature, structure, or characteristic, but not every embodiment necessarily includes the particular feature, structure, or characteristic. Moreover, such phrases do not necessarily refer to the same embodiment. Further, when a particular feature, structure, or characteristic is described in connection with one embodiment, it should be understood that such feature, structure, or characteristic may also be used in connection with other embodiments, whether or not explicitly described, unless clearly stated to the contrary.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one embodiment being used in other embodiments.

1. A gesture recognition system comprising:
at least one infrared sensor;
a first infrared light emitting diode (LED) providing a first far-field radiation beam that extends from the first infrared LED and defines a first central ray;
a second infrared light emitting diode (LED) providing a second far-field radiation beam that extends from the second infrared LED and defines a second central ray;
wherein the first far-field radiation beam does not overlap with the second far-field radiation beam.

2. The gesture recognition system of claim 1, further comprising at least a third infrared LED providing a third far-field radiation beam that extends from the third infrared LED; wherein the third far-field radiation beam does not overlap with any of the first and second far-field radiation beams.

3. The gesture recognition system of claim 1, wherein the first central ray and the second central ray define an intersection point and an angle of intersection.

4. The gesture recognition system of claim 3, wherein the angle of intersection between the first and second central rays is larger than a divergence angle of at least one of the first and second far-field radiation beams.

5. The gesture recognition system of claim 1, further comprising
an LED driver circuit that is integrated into the system, synchronized with the infrared sensor, and structured and arranged to drive the LEDs with a time-division multiplexing method;
an algorithm processor coupled with the infrared sensor to receive a signal from the infrared sensor; the signal representing an intensity of a return light that is scattered by a gesture object from at least one of the first and second far-field radiation beams emitted from the LEDs in a time-division multiplexing manner;
wherein the algorithm processor is structured and arranged to identify a gesture.

6. The gesture recognition system of claim 1, further comprising a protruding substrate that comprises a first portion and a second portion, wherein at least one of the first and second portions has at least one of the first and second infrared LEDs disposed therein or thereon.

7. The gesture recognition system of claim 1, further comprising a lens, wherein at least one of the first and second central rays extends from the lens.

8. The gesture recognition system of claim 1, the system comprising a module that comprises at least first and second compartments, a first package comprising a first cover disposed in the first compartment, the first cover covering the first and second infrared LEDs, the first package disposed in the first compartment, a second package comprising a second cover covering the at least one infrared sensor, the second package disposed within the second compartment that is separated from the first compartment by an isolation barrier to prevent the near-field light couple from the first and second infrared LEDs to the sensor.

9. The gesture recognition system of claim 1 wherein the first central ray and the second central ray are non-parallel.

10. A gesture recognition system comprising:
a first radiation source providing a first beam comprising a first central ray;
a second radiation source providing a second beam comprising a second central ray; and
a radiation sensor;
wherein the first beam and the second beam do not overlap.

11. The gesture recognition system of claim 10, wherein at least one of the first and second radiation sources comprises an infrared LED.

12. The gesture recognition system of claim 10, wherein at least one of the first and second radiation sources comprises a laser.

13. The gesture recognition system of claim 10, comprising a cover, the first beam passing through the cover, the second beam passing through the cover.

14. The gesture recognition system of claim 13, wherein the cover is arranged to cover the radiation sensor.

15. The gesture recognition system of claim 14, wherein the cover comprises a single, continuous piece of material.

16. The gesture recognition system of claim 10, wherein first central ray and the second central ray are non-parallel.

17. The gesture recognition system of claim 10, wherein the first central ray is oriented at a non-zero angle to the second central ray, the first beam comprises a divergence angle, the non-zero angle being greater than the divergence angle.

18. The gesture recognition system of claim 17, wherein the second beam comprises a divergence angle that is equal to or less than the divergence angle of the first beam.

19. The gesture recognition system of claim 10, further comprising a third radiation source providing a third beam, the third beam not overlapping the first beam, the third beam not overlapping the second beam.

20. The gesture recognition system of claim 10, comprising a cover, the first beam and the second beam passing through the cover, wherein the first central ray and the second central ray are parallel prior to passing through the cover.
